(19) United States
(12) Patent Application Publication
(10) Pub. No.: US 2026/0036747 A1
(43) Pub. Date: Feb. 5, 2026

(54) PREPARATION METHOD OF MULTI-LAYER STACKED WAVEGUIDE

(71) Applicant: FOCI FIBER OPTIC COMMUNICATIONS, INC., HSINCHU (TW)

(72) Inventors: Ting-Ta Hu, HSINCHU (TW); Po-Yi Wu, HSINCHU (TW); Chieh-Yu Fang, HSINCHU (TW); Ting-Yan Lin, HSINCHU (TW)

(21) Appl. No.: 18/906,212

(22) Filed: Oct. 4, 2024

(30) Foreign Application Priority Data
Aug. 2, 2024 (TW) 113129065

(51) Int. Cl. G02B 6/13; G02B 6/12

(52) U.S. Cl. CPC G02B 6/13; G02B 2006/12197

(57) ABSTRACT

The present invention relates to a preparation method of multi-layer stacked waveguide. The method involves a preliminary step: providing an optical waveguide block, wherein the optical waveguide block has a substrate and a plurality of optical waveguides, the optical waveguides are disposed within the substrate and adjacent to an upper surface of the substrate; and a bonding step: flipping over another optical waveguide block and bonding it above the optical waveguide block to form a double-layer stacked waveguide structure. In this way, a multi-layer waveguide stack structure can be formed by directly stacking optical waveguide blocks directly provided with a plurality of optical waveguides. Multi-layer stacking only needs to be completed by heating, thinning and/or depositing a silicon oxide layer, saving manufacturing time and cost.

### CROSS-REFERENCE TO RELATED APPLICATION

This application claims the priority of Taiwanese patent application No. 113129065, filed on Aug. 2, 2024, which is incorporated herewith by reference.

### BACKGROUND OF THE INVENTION

### 1. Field of the Invention

The present invention relates generally to a technical field of stacked waveguide, and more particularly, to preparation method of multi-layer stacked waveguide.

### 2. The Prior Arts

For currently known multi-layer waveguide optical couplers, refer to the Taiwan Patent No. 202349044 and 202349046, which disclose a method of manufacturing method of an optical coupler having a first light receiving end and a second light output end opposite to the first light receiving end, including: forming a cladding layer from a cladding material having a first refractive index; and forming a core layer inside the cladding layer, the core layer having a plurality of waveguides, and being made of a core material having a second refractive index, which is greater than the first refractive index. The steps to form each layer must include depositing a cladding layer and depositing/patterning a waveguide core layer, which wastes process time and materials.

### SUMMARY OF THE INVENTION

A primary objective of the present invention is to provide a preparation method of multi-layer stacked waveguide, which can form a multi-layer waveguide stack structure by directly stacking optical waveguide blocks including a plurality of optical waveguides, and the stacking process only requires heating, thinning, and/or deposited silicon oxide layers to complete multi-layer stacking, saving process time and cost.

Another objective of the present invention is to provide a preparation method of multi-layer stacked waveguide, which can form alignment marks on the optical waveguide blocks so that a plurality of stacked optical waveguide blocks can be aligned with each other during bonding to improve manufacturing yield.

In order to achieve the aforementioned objectives, the present invention provides a preparation method of multi-layer stacked waveguide, which includes: a preliminary step: providing a first optical waveguide block, wherein the optical waveguide block having a substrate and a plurality of optical waveguides, the optical waveguides being disposed within the substrate and adjacent to an upper surface of the substrate; and a bonding step: flipping a second optical waveguide block and bonding to above the first optical waveguide block to form a double-layer stacked waveguide structure.

In some embodiments, the optical waveguides are parallel to each other and spaced apart from each other.

In some embodiments, before the bonding step, an applying step is further included, and the applying step includes applying a silicon oxide layer on the upper surface of the first optical waveguide block.

In some embodiments, in the bonding step, the flipped second optical waveguide block is bonded to above the first optical waveguide block through the silicon oxide layer.

In some embodiments, after the bonding step, a heating step is further included, and the heating step includes performing a heating process to allow the first optical waveguide block to bond with the flipped second optical waveguide through the silicon oxide layer.

In some embodiments, the first optical waveguide block has the same structure as the second optical waveguide block.

In some embodiments, the optical waveguide block is formed with at least two alignment marks on the first optical waveguide block through a patterning operation.

In some embodiments, each alignment mark has a height lower than a height of the silicon oxide layer.

In some embodiments, after the heating step, a thinning step is further included, and the thinning step includes thinning a thickness of the second optical waveguide block until it is close to a thickness of the plurality of optical waveguides of the second optical waveguide block.

In some embodiments, after the bonding step, the applying step, the bonding step, the heating step and the thinning step are repeatedly performed on the double-layer stacked waveguide structure to form a multi-layer stacked waveguide structure.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a schematic flow chart of a preparation method of multi-layer stacked waveguide according to the present invention.

FIG. 2 is a schematic view of a structure in the preparation method of multi-layer stacked waveguide according to the present invention.

FIG. 3 is a schematic view of a structure in the preparation method of multi-layer stacked waveguide according to the present invention.

FIG. 4 is a schematic view of a structure in the preparation method of multi-layer stacked waveguide according to the present invention.

FIG. 5 is a schematic view of a structure in the preparation method of multi-layer stacked waveguide according to the present invention.

FIG. 6 is a schematic view of a structure forming a multi-layer stacked waveguide in the manufacturing method of the multi-layer stacked waveguide of the present invention.

FIG. 7 is a schematic view of the structure shown in FIG. 4 applied to a two-dimensional optical fiber array module in the preparation method of the multi-layer stacked waveguide of the present invention.

FIG. 8 is a perspective view of FIG. 7.

### DETAILED DESCRIPTION OF THE PREFERRED EMBODIMENT

The accompanying drawings are included to provide a further understanding of the invention, and are incorporated in and constitute a part of this specification. The drawings illustrate embodiments of the invention and, together with the description, serve to explain the principles of the invention.

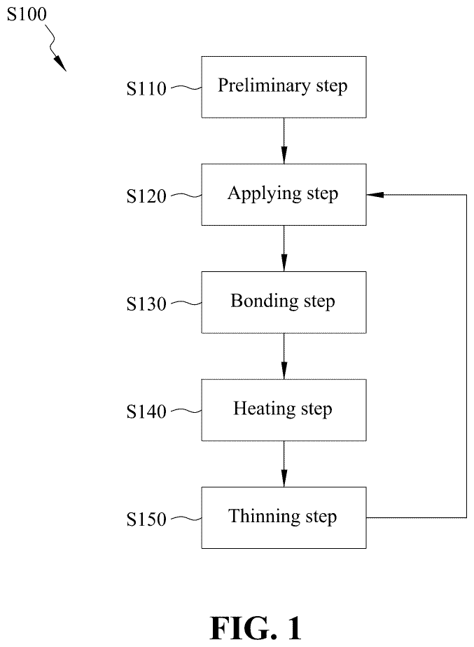

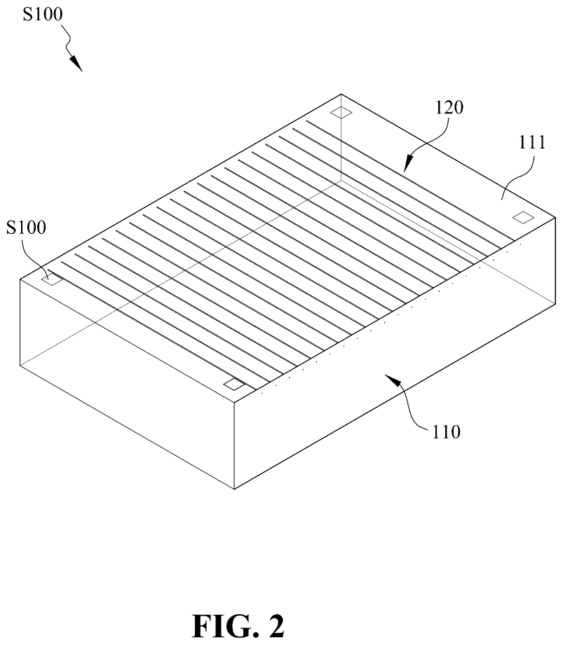

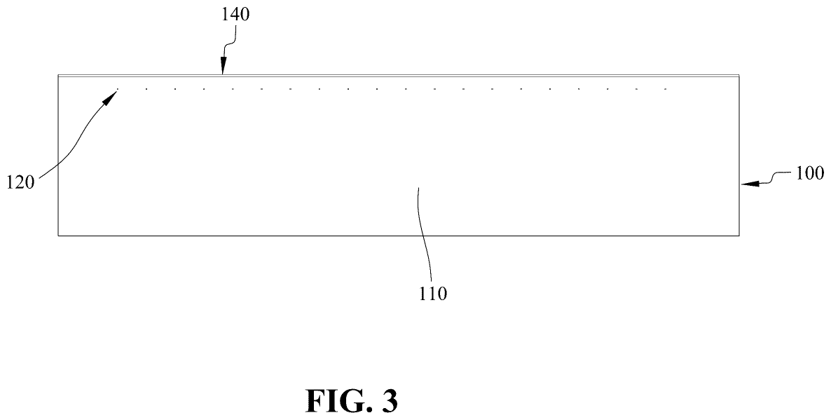

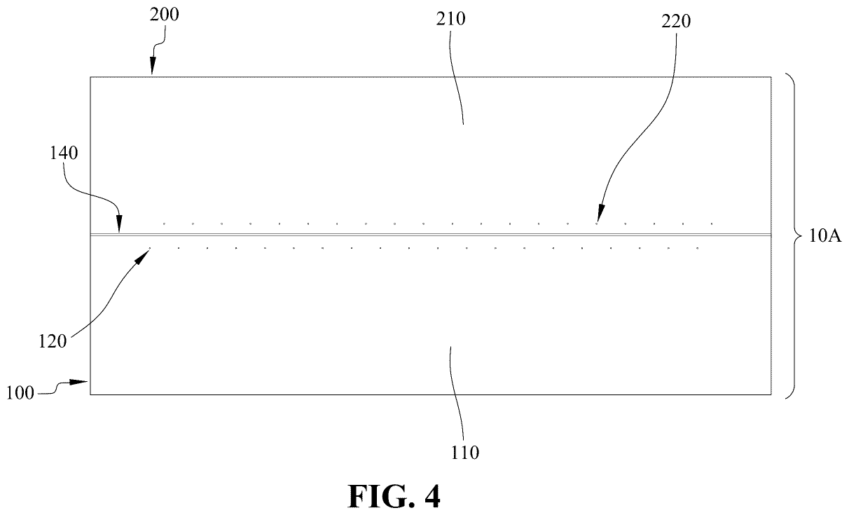

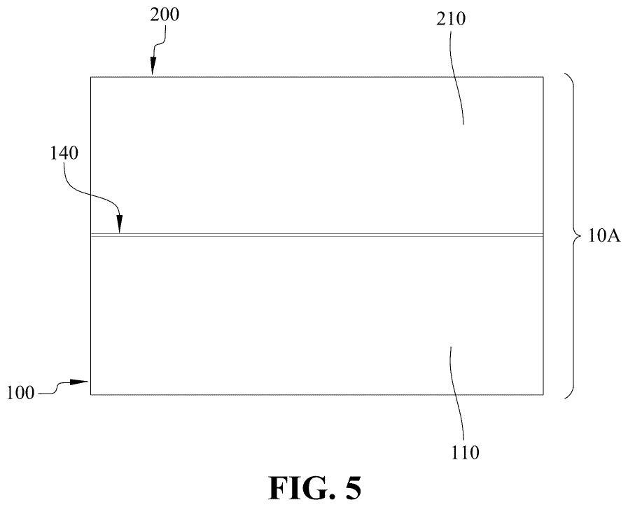

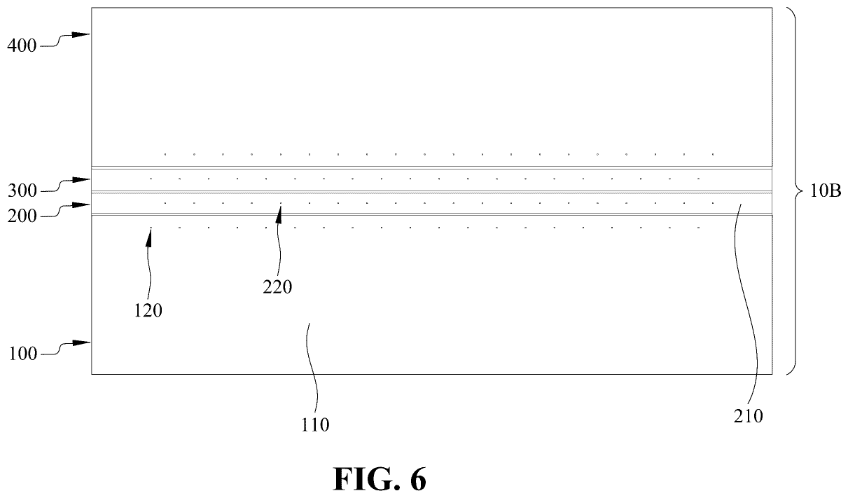

FIG. 1 is a schematic flow chart of a preparation method of multi-layer stacked waveguide according to the present invention; FIG. 2 is a schematic view of a structure in the preparation method of multi-layer stacked waveguide according to the present invention; FIG. 3 is a schematic view of a structure in the preparation method of multi-layer stacked waveguide according to the present invention; FIG. 4 is a schematic view of a structure in the preparation method of multi-layer stacked waveguide according to the present invention; FIG. 5 is a schematic view of a structure in the preparation method of multi-layer stacked waveguide according to the present invention; and FIG. 6 is a schematic view of a structure forming a multi-layer stacked waveguide in the manufacturing method of the multi-layer stacked waveguide of the present invention.

Referring to FIGS. 1 to 6, the preparation method S100 of multi-layer stacked waveguide of the present invention includes a preliminary step S110, an applying step S120, a bonding step S130, and a heating step S140.

Refer to FIG. 1 and FIG. 2. In the preliminary step S110, an optical waveguide block 100 is provided. In some embodiments, the optical waveguide block 100 may have a substrate 110 and a plurality of optical waveguides 120, and the optical waveguides 120 are disposed within the substrate 110 and adjacent to an upper surface 111 of the substrate 110.

In some embodiments, the optical waveguides 120 may be arranged parallel to each other and spaced apart from each other. In some embodiments, the optical waveguide block 100 can also form at least two alignment marks 130 on the optical waveguide block 100 through a patterning operation. In the present embodiment, four alignment marks are used as an example for description, but the invention is not limited thereto. In the present embodiment, four alignment marks 130 are respectively provided at four corners of the optical waveguide block 100.

Refer to FIGS. 1, 4 and 5. In the bonding step S130, a second optical waveguide block 200 is flipped over and bonded on top of the optical waveguide block 100 to form a double-layer stacked waveguide structure 10A. In some embodiments, the structures of the optical waveguide block 100 and the optical waveguide block 200 may be the same, that is, the optical waveguide block 200 may have a substrate 210 and a plurality of optical waveguides 220. Similarly, alignment marks (not shown) may also be formed on the optical waveguide block 200 so that the optical waveguide block 200 and the optical waveguide block 100 can be aligned during the bonding step. In some embodiments, the substrate 110 and the substrate 210 may be made of silicon or glass, but are not limited thereto. In the present embodiment, the optical waveguide block 100 and the optical waveguide block 200 can be bonded by using an oxide generated on the surfaces facing each other in a high temperature and high pressure environment, or by the applying step S120 and heating step S140 to complete the bonding, which will be described in detail below.

Refer to FIG. 1 and FIG. 3. Before the bonding step S130, the preparation method also includes an applying step S120. The applying step S120 may include applying a silicon oxide layer 140 on the upper surface 111 of the optical waveguide block 100. In some embodiments, the method of applying the silicon oxide layer 140 to the optical waveguide block 100 includes deposition or coating, but is not limited thereto. After the applying step S120, the optical waveguide block 200 that has been flipped in the bonding step S130 can be bonded to the upper surface of the optical waveguide block 100 through the silicon oxide layer 140.

Refer to FIGS. 1, 4 and 5 again. After the bonding step S130, a heating step S140 may also be included. The heating step S140 may include performing a heating process to allow the optical waveguide block 100 to adhere to the flipped optical waveguide block 200 through the silicon oxide layer 140. In some embodiments, a height of each alignment mark 130 is lower than a height of the silicon oxide layer 140.

Refer to FIG. 1 and FIG. 6 again. After the heating step S140, a thinning step S150 may also be included. The thinning step S150 may include thinning a thickness of the optical waveguide block 200 until the optical waveguide block 200 is close to the plurality of optical waveguides 220 of the optical waveguide block 200. In some embodiments, the thinning step S150 can be implemented through a grinding operation or a polishing operation, but is not limited thereto. In some embodiments, after the bonding step S130, the steps S120-S150, i.e., the applying step S120, the bonding step S130, the heating step S140 and the thinning step S150, may be repeatedly performed on the double-layer stacked waveguide structure 10A to form a multi-layer stacked waveguide structure 10B comprising the optical waveguide block 100, the optical waveguide block 200, the optical waveguide block 300, and the optical waveguide block 400.

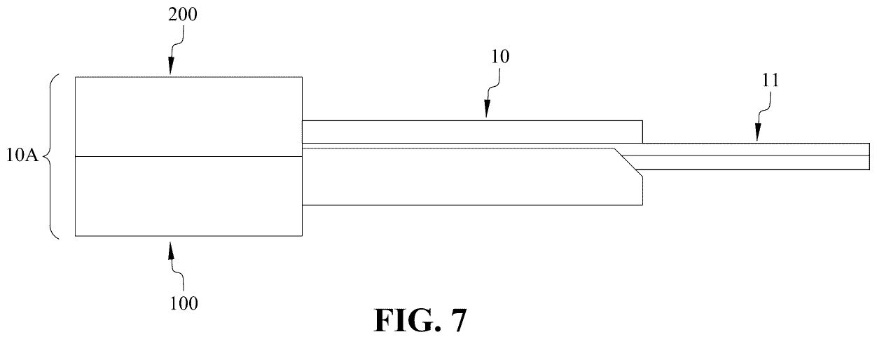

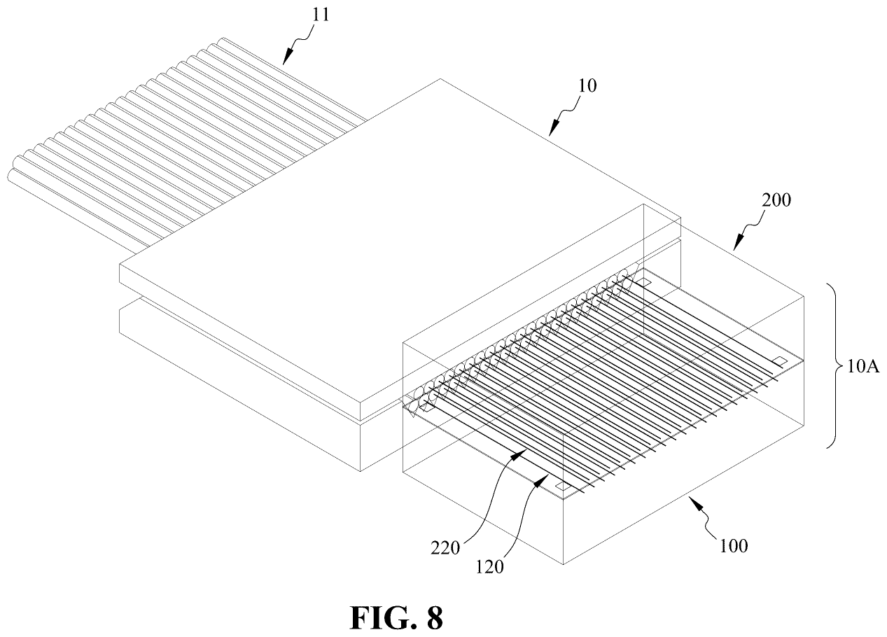

FIG. 7 is a schematic view of the structure shown in FIG. 4 applied to a two-dimensional optical fiber array module in the preparation method of the multi-layer stacked waveguide of the present invention. FIG. 8 is a perspective view of FIG. 7.

The double-layer stacked waveguide structure 10A can be connected to the two-dimensional (two-layer) optical fiber array module 10, and each optical waveguide (i.e., the optical waveguide 120 and the optical waveguide 220) of the double-layer stacked waveguide structure 10A can be configured to correspond to each optical fiber 11 of the two-dimensional optical fiber of the array module 10 to transmit light beams. In other words, the number of layers of the multi-layer stacked waveguide structure 10B can be set corresponding to the number of optical fiber array layers of the multi-dimensional (multi-layer) optical fiber array module 10.

In summary, the multi-layer stacked waveguide preparation method S100 of the present invention can be achieved by directly stacking a plurality of optical waveguide blocks (i.e., optical waveguide block 100 and optical waveguide block 200) with a plurality of optical waveguides (i.e., optical waveguide 120 and optical waveguide 220) to form a multi-layer waveguide stack structure, and the multi-layer stack can be completed by heating, thinning and/or depositing a silicon oxide layer, thereby saving process time and cost. Furthermore, the multi-layer stacked waveguide preparation method S100 of the present invention can form alignment marks (i.e., alignment marks 130) on the optical waveguide blocks (i.e., the optical waveguide block 100 and the optical waveguide block 200), so that the plurality of optical waveguide blocks to be stacked can be aligned with each other during bonding to improve manufacturing yield.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A preparation method of multi-layer stacked waveguide, comprising:
a preliminary step: providing a first optical waveguide block, wherein the optical waveguide block having a substrate and a plurality of optical waveguides, the optical waveguides being disposed within the substrate and adjacent to an upper surface of the substrate; and
a bonding step: flipping a second optical waveguide block and bonding to above the first optical waveguide block to form a double-layer stacked waveguide structure.

2. The preparation method of multi-layer stacked waveguide according to claim 1, wherein the optical waveguides are parallel to each other and spaced apart from each other.

3. The preparation method of multi-layer stacked waveguide according to claim 1, wherein before the bonding step, an applying step is further included, and the applying step includes applying a silicon oxide layer on the upper surface of the first optical waveguide block.

4. The preparation method of multi-layer stacked waveguide according to claim 3, wherein in the bonding step, the flipped second optical waveguide block is bonded to above the first optical waveguide block through the silicon oxide layer.

5. The preparation method of multi-layer stacked waveguide according to claim 4, wherein after the bonding step, a heating step is further included, and the heating step includes performing a heating process to allow the first optical waveguide block to bond with the flipped second optical waveguide through the silicon oxide layer.

6. The preparation method of multi-layer stacked waveguide according to claim 5, wherein the first optical waveguide block has the same structure as the second optical waveguide block.

7. The preparation method of multi-layer stacked waveguide according to claim 6, wherein the optical waveguide block is formed with at least two alignment marks on the first optical waveguide block through a patterning operation.

8. The preparation method of multi-layer stacked waveguide according to claim 7, wherein each alignment mark has a height lower than a height of the silicon oxide layer.

9. The preparation method of multi-layer stacked waveguide according to claim 8, wherein a thinning step is further included, and the thinning step includes thinning a thickness of the second optical waveguide block until it is close to a thickness of the plurality of optical waveguides of the second optical waveguide block.

10. The preparation method of multi-layer stacked waveguide according to claim 9, wherein after the bonding step, the applying step, the bonding step, the heating step and the thinning step are repeatedly performed on the double-layer stacked waveguide structure to form a multi-layer stacked waveguide structure.
